(19) United States
(12) Patent Application Publication
(10) Pub. No.: US 2015/0287095 A1
(43) Pub. Date: Oct. 8, 2015

(54) PROFILING INFRINGING ACTIVITY OF CONTENT CONSUMERS FOR DIGITAL ADVERTISERS

(71) Applicant: Singularis, Inc., Laverock, PA (US)

(72) Inventor: Emanuel I. Wald, Laverock, PA (US)

(73) Assignee: Singularis, Inc.

(21) Appl. No.: 14/747,344

(22) Filed: Jun. 23, 2015

Related U.S. Application Data
(63) Continuation-in-part of application No. 13/290,469, filed on Nov. 7, 2011.

(51) Int. Cl. G06Q 30/02; G06Q 30/00; H04L 29/08

(52) U.S. Cl. CPC G06Q 30/0269; H04L 67/22; G06Q 30/018

(57) ABSTRACT

Profiles of consumers may be built based on observed infringing activity over time. Infringement-based consumer segmentation information may be provided to digital advertisers to more accurately target consumers. Additionally, since the marketer may be willing to pay for the use of this data, the copyright holders whose works have been exploited can benefit from the fact that this observation of infringement is providing value to marketers by receiving a share of the revenue paid by the marketer for the intelligence gleaned from access to the information.

### CROSS-REFERENCE TO RELATED APPLICATION

This application is a continuation-in-part of U.S. patent application Ser. No. 13/290,469, filed on Nov. 7, 2011. The subject matter of this earlier-filed application is hereby incorporated by reference in its entirety.

### FIELD

The present invention pertains to user profiling, and more particularly, to building profiles of consumers based on observed infringing activity and providing access to this information to digital advertisers.

### BACKGROUND

Digital marketers benefit from targeting their customer acquisition efforts when targeting customers online. For instance, an advertiser may use information about a consumer to decide whether to show a particular ad to the customer. The advertiser may incorporate information acquired from third parties to make the determination as to whether a consumer is in the market for the advertiser's product or service. Third parties may be paid a fee for the provision of this information. The demand for such services is increasing as online marketing efforts are reaching levels that have never been seen before. According to Forrester Research™ from 2014 to 2019, digital marketing spend will exceed $100 B annually. See https://www.forrester.com/US+Digital+Marketing+Forecast+2014+To+2019/fulltext/-/E-RES116965. This exceeds television advertising.

However, infringing activity is not tracked and used for the purposes of advertising. Accordingly, an improved approach to profiling and monetizing such infringing activity may be beneficial.

### SUMMARY

Certain embodiments of the present invention may provide solutions to the problems and needs in the art that have not yet been fully identified, appreciated, or solved by current consumer profiling systems. For example, some embodiments of the present invention pertain to building profiles of consumers based on observed infringing activity and facilitating access to this information by digital advertisers to more accurately target consumers.

In an embodiment, a computer-implemented method includes receiving a request from a marketer, by a data store or a computing system associated with the data store, for online infringement-based consumer segmentation data pertaining to a consumer infringing online content. The computer-implemented method also includes authenticating the request and checking whether the marketer associated with the request is authorized, by the data store or the computing system associated with the data store. The computer-implemented method further includes, when the request is authenticated and the marketer is authorized, sending, by the data store or the computing system associated with the data store, a response to the marketer reflecting one or more segments into which the infringing consumer falls.

In another embodiment, a computer program is embodied on a non-transitory computer-readable medium. The program is configured to cause at least one processor to transmit a share of a fee or a separate specific fee required by a copyright holder to access online infringement-based consumer segmentation data to a marketer and receive a request from the marketer for online infringement-based consumer segmentation data pertaining to a consumer infringing online content. The computer program is also configured to cause the at least one processor to authenticate the request and check whether the marketer associated with the request is authorized and send a response to the marketer reflecting one or more segments into which the infringing consumer falls when the request is authenticated and the marketer is authorized. The computer program is further configured to cause the at least one processor to charge the marketer a fee for access to the online infringement-based consumer segmentation data pertaining to the consumer and provide a share of the fee, or a separate specific fee, to a copyright holder of the infringed online content.

In yet another embodiment, an apparatus includes memory storing computer program instructions and at least one processor communicably coupled to the memory configured to execute the computer program instructions. The at least one processor is configured to periodically query a plurality of nodes on a distributed network regarding infringing activity of monitored content by consumers and evaluate responses from the plurality of nodes to identify the infringing activity of the monitored content. The at least one processor is also configured to create respective profiles for a plurality of infringing consumers based on observed patterns of infringing behavior in the evaluated responses.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flowchart illustrating a process for profile creation, according to an embodiment of the present invention.

FIG. 2 is a flowchart illustrating a process for consumer profile consumption, according to an embodiment of the present invention.

FIG. 3 is a flowchart illustrating a process for content orchestration, according to an embodiment of the present invention.

FIG. 4 is a flowchart illustrating a process for a content leader, according to an embodiment of the present invention.

FIG. 5 is a flowchart illustrating a process for a bootstrapper, according to an embodiment of the present invention.

FIG. 6 is a flowchart illustrating a process for a processer, according to an embodiment of the present invention.

FIG. 7 is a flowchart illustrating a process for a parser, according to an embodiment of the present invention.

FIG. 8 is a flowchart illustrating a process for profiling infringing activity, according to an embodiment of the present invention.

FIG. 9 is a block diagram illustrating a computing system configured to profile infringing activity, according to an embodiment of the present invention.

### DETAILED DESCRIPTION OF THE EMBODIMENTS

Some embodiments of the present invention pertain to building profiles of consumers based on observed infringing activity and facilitating access to this information by digital advertisers to more accurately target consumers. A consumer profile can be built from the observation of infringing activity over time. For example, if an individual is seen downloading a football game, a video game, and an e-book on software development in a particular programming language, certain assertions can be made about this individual. For instance, it can be assumed that this person is a sports enthusiast, a gamer, and an information technology (IT) professional, as well as an individual that engages in repeated copyright infringement. These types of consumer classifications or segments may be associated with specific Internet Protocol (IP) addresses and timestamps.

Some embodiments allow marketers to consume infringement-based consumer segmentation data in real time or near-real time via a request to a server that has access to a data store in which the records of consumer segmentation, IP addresses, and timestamp information are maintained. The input for the request may include the identity of the requestor, an authentication token, and an IP address. If the request is properly authenticated, and the requestor is authorized, the requestor will receive a response reflecting the various segments into which the consumer to whom the submitted request pertains falls.

In the example from the previous paragraph, if the IP address of the individual committing the infringing activity is 1.2.3.4, and a digital marketer wants to make a decision on whether to show an ad to a consumer from this IP address or to purchase the consumer data from a third party that was entered into an online form from this IP address, the marketer could make a request to the system and input the IP address. In real time or near-real time, the system may look up the IP address 1.2.3.4 and find a record indicating that the associated individual has been identified as a sports enthusiast, a gamer, and an IT professional. This segmentation information may then be returned in a response to the marketer.

Additionally, since the marketer may be willing to pay for the use of this data, the copyright holders whose works have been exploited can benefit from the fact that this observation of infringement is providing value to marketers. More specifically, the rights holders can receive a share of the revenue paid by the marketer for the intelligence gleaned from access to the data. Rights holders may configure what percentage of the fee they require, or a specific fee, through the system. Marketers may factor this fee into their decision as to whether to purchase this data.

Consumer Profile Creation

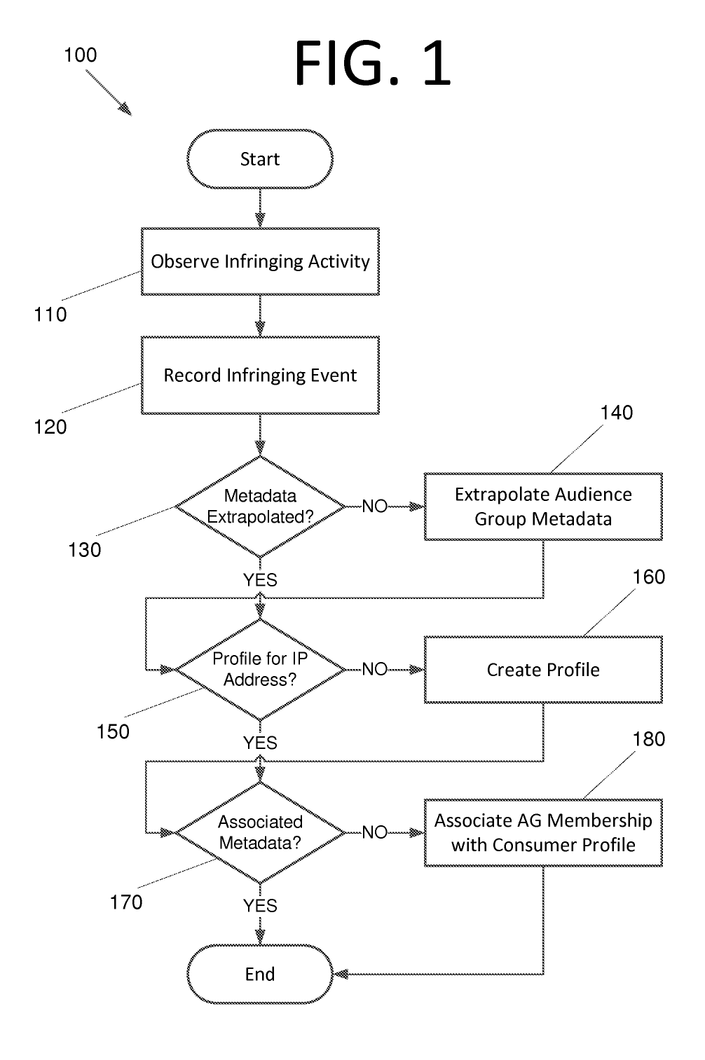

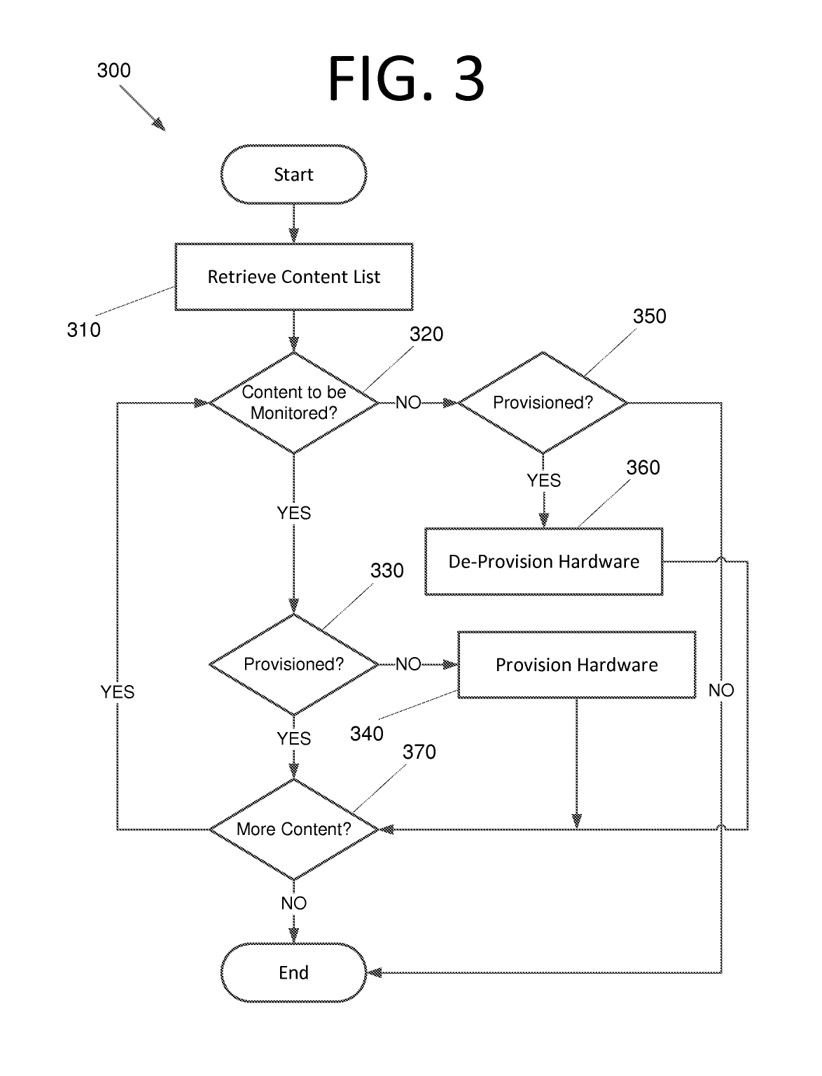

Consumer profiles may be built based on observed patterns of infringing behavior. FIG. 1 is a flowchart illustrating a process 100 for profile creation, according to an embodiment of the present invention. The process begins with observing infringing activity at 110 by creating and storing node records, where each stored node record has an IP address in some embodiments and can potentially be a data source for the consumer profile. The process of some embodiments is shown in FIGS. 3-7 below. Once the infringing activity is observed, a record of the infringing event is made at 120. This record may include, but is not limited to, the IP address of the infringer, the infringed content, and/or the time that the infringing event occurred.

Next, the system determines whether audience group metadata has been extrapolated from the content at 130. If yes, the process continues to step 150. If no, audience group metadata is extrapolated from the content at 140. To extrapolate metadata from the content, each piece of content that is being monitored in the system may have an arbitrary set of associated properties. The values for each property may have different associated audience groups. For instance, if the content being monitored is an action-adventure film, then a “Young to Middle Age” audience group may be associated with the content. Conversely, if the content being monitored is a drama film, then a “Middle Age to Older” audience group may be associated with the content. The relationships between film genres like this and audience group membership may then be applied to a piece of content in order to classify an individual observed reproducing or distributing that content from a particular IP address. In other words, the nature of the content tends to provide certain information about the likely characteristics of the viewer.

The system then determines whether a consumer profile exists for the IP address at 150. If yes, the process continues to step 170. If no, a consumer profile is created at 160. The consumer profile may contain information including, but not limited to, the IP address, timestamp first seen, timestamp last seen, client software observed using, and/or a collection of audience groups to which the consumer belongs.

If audience group metadata is associated with the consumer profile at 170, the process ends. If audience group metadata is not associated with the consumer profile at 170, the audience group membership is associated with the consumer profile at 180. To associate audience group membership with the consumer profile, the consumer profile record may be updated, the last seen timestamp field may be set to the current timestamp, and the audience group membership collection may be set to reflect the set of related audience groups based on the content observed being infringed from the consumer's IP address. The process then ends.

Consumer Profile Consumption

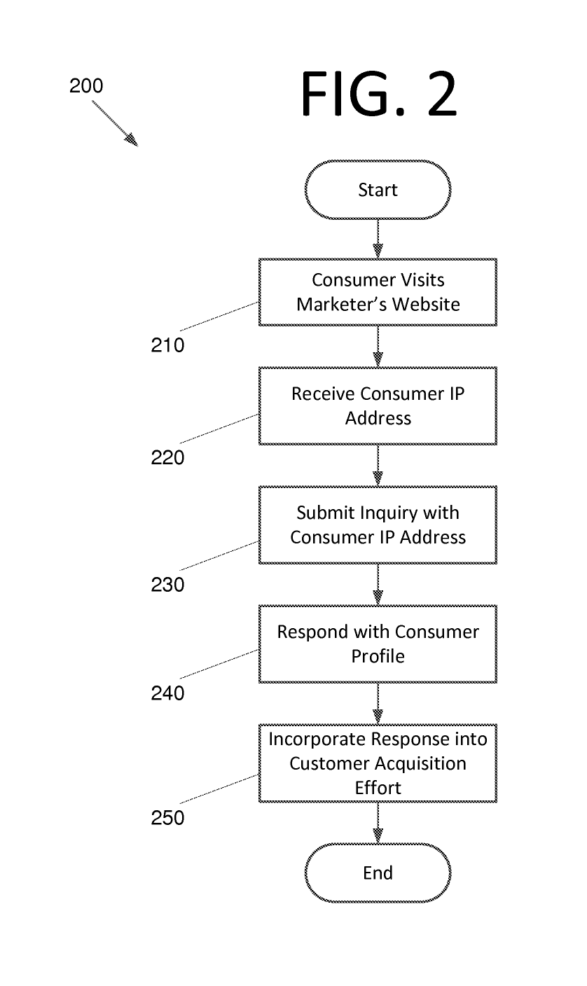

Users of consumer profile information, such as digital marketers, may consume the profile information in some embodiments. FIG. 2 is a flowchart illustrating a process 200 for consumer profile consumption, according to an embodiment of the present invention. The process begins with a consumer visiting a digital marketer's website at 210. The digital marketer receives the IP address from which the consumer's HTTP request initiated in a header at 220.

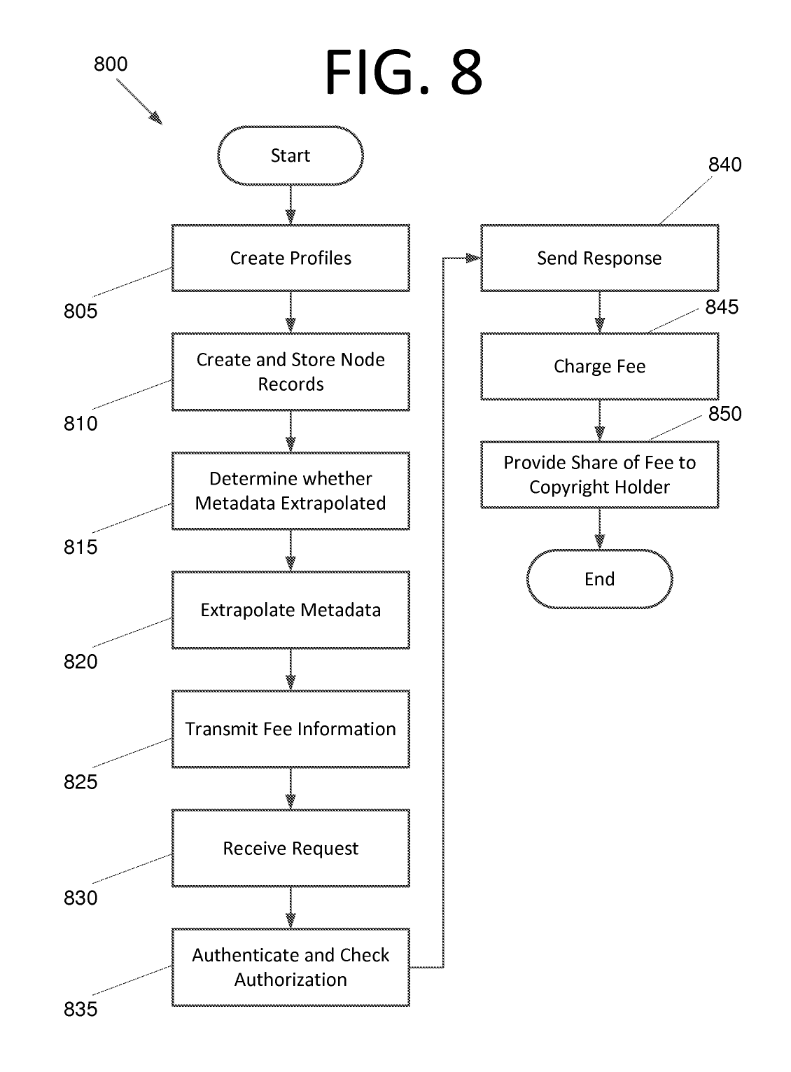

The digital marketer then submits an inquiry to a system, such as computing system 800 of FIG. 8, with the consumer IP address as an input at 230. The system responds with the profile of the consumer associated with the IP address at 240. The digital marketer incorporates response in real-time into its customer acquisition effort at 250. For instance, a digital marketer may factor the consumer's audience group membership into its decision as to which ad to display. If the consumer falls into the “Young to Middle Age” group, for instance, the digital marketer may choose to display an ad targeted more toward this demographic. The process then ends.

Content Orchestrator

The role of the content orchestrator process in some embodiments is to ensure that the hardware necessary to monitor the content that should be monitored has been provisioned. Conversely, the content orchestrator may also be responsible for de-provisioning hardware from content that should no longer be monitored for which hardware was previously provisioned. FIG. 3 is a flowchart 300 illustrating a process for content orchestration, according to an embodiment of the present invention. The process begins with the content orchestrator retrieving a list of pieces of content from a database at 310. For each piece of content that should be monitored, the content orchestrator checks to see whether the content is to be monitored at 320. If yes, the content orchestrator checks whether hardware has been provisioned to monitor that content at 330. If no at 330, the content orchestrator provisions hardware to begin monitoring the content at 340, and the process proceeds to step 370. If yes, the process proceeds to step 370.

If content should not be monitored at 320 (i.e., the “NO” branch”), the content orchestrator checks to see whether hardware has been provisioned for that content at 350. If yes at 350, the content orchestrator sends a signal to the provisioned hardware to cease monitoring the content and de-provisions the hardware at 360, and the process proceeds to step 370. At 370, the content orchestrator checks whether there is more content on the content list. If yes, the process proceeds to step 320 and repeats as discussed above. If no, the process ends.

Content Leader

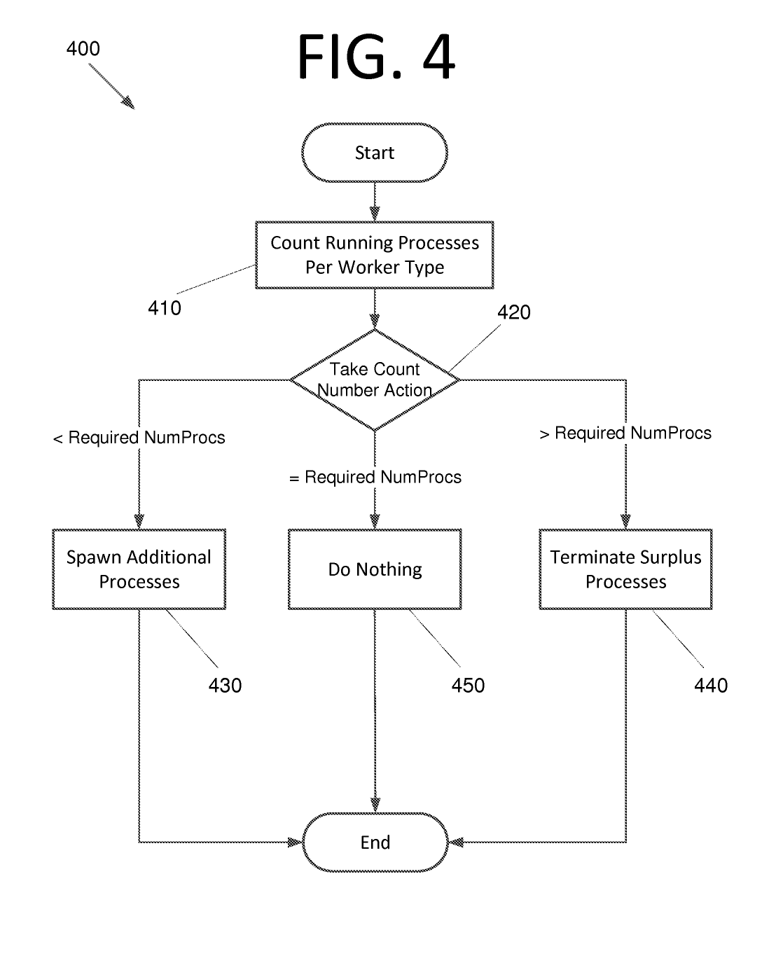

The role of the content leader process in some embodiments is to ensure that the correct number and type of worker processes are running in order to monitor content. Each piece of content being monitored may have one content leader process that runs on its hardware at a configurable interval. FIG. 4 is a flowchart 400 illustrating a process for a content leader, according to an embodiment of the present invention. For each type of worker, the content leader gets a count of how many processes are running of this worker type at 410. If the count is less than the required number of worker processes of this type at 420, the content leader spawns an additional number of processes to compensate for the deficit at 430. If the count is greater than the required number of worker processes of this type, the content leader terminates the superfluous processes to eliminate the surplus at 440. If the count is equal to the required number of worker processes of this type, the content leader does nothing at 450 since the correct number of processes is running. The process then ends.

Content Workers

The role of the content worker processes may be to query nodes on a distributed network, evaluate the responses from these nodes in order to identify infringing activity, and persist a record of these observations. The nodes may be the individual computing systems in the distributed network across which the content is being reproduced and distributed. One can think of each node as an individual participant (or infringer) in the distributed network. The distributed network itself may be composed of a collection of nodes (i.e., computing systems), each of which is a member of the network, and collectively make up the network. There are 3 content worker process types in some embodiments: a bootstrapper, a processer, and a parser.

Bootstrapper

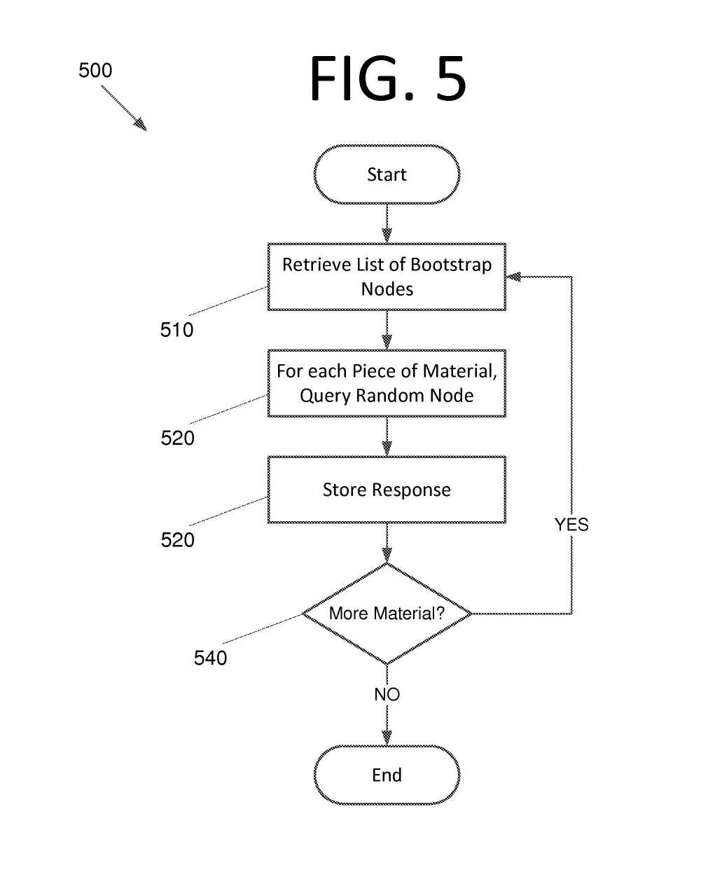

The bootstrapper may be responsible for performing initial queries of nodes in the distributed network and saving a record of the response in order to begin the process of finding infringing activity associated with the content being monitored. FIG. 5 is a flowchart 500 illustrating a process for a bootstrapper, according to an embodiment of the present invention. The process begins with retrieving a list of bootstrap nodes from a database at 510. In some embodiments, the list may be predetermined. For each piece of material for the piece of content that is being monitored, a random node is queried from the list of bootstrap nodes at 520. There may be multiple reproductions of the same piece of content (i.e., “material”). For instance, the same episode of a television show may be reproduced in several different file formats and distributed over a network. Each file would be considered a unique piece of content for the purposes of some embodiments. The response from the bootstrap node is then stored in the database with the state “unprocessed” and status “not processed” at 530.

In some embodiments, the node record includes, but is not limited to, a content identifier, a material identifier, an IP address, a port, a state, a status, a timestamp of when the node record was added, a client software identifier, a number of other nodes received in the response, a timestamp of when the request was sent to the node, a timestamp of when the response was received from the node, and a raw response received from the node. In some embodiments, the valid states include unprocessed, processed, and parsed. In certain embodiments, the valid statuses include not processed (unprocessed state), started query (unprocessed state), queried (processed state), started parse (processed state), no response (processed state), invalid response (parsed state), and received response (parsed state). If there is more material for the piece of content at 540, the process returns to step 510. If there is no more material, the process ends.

Processer

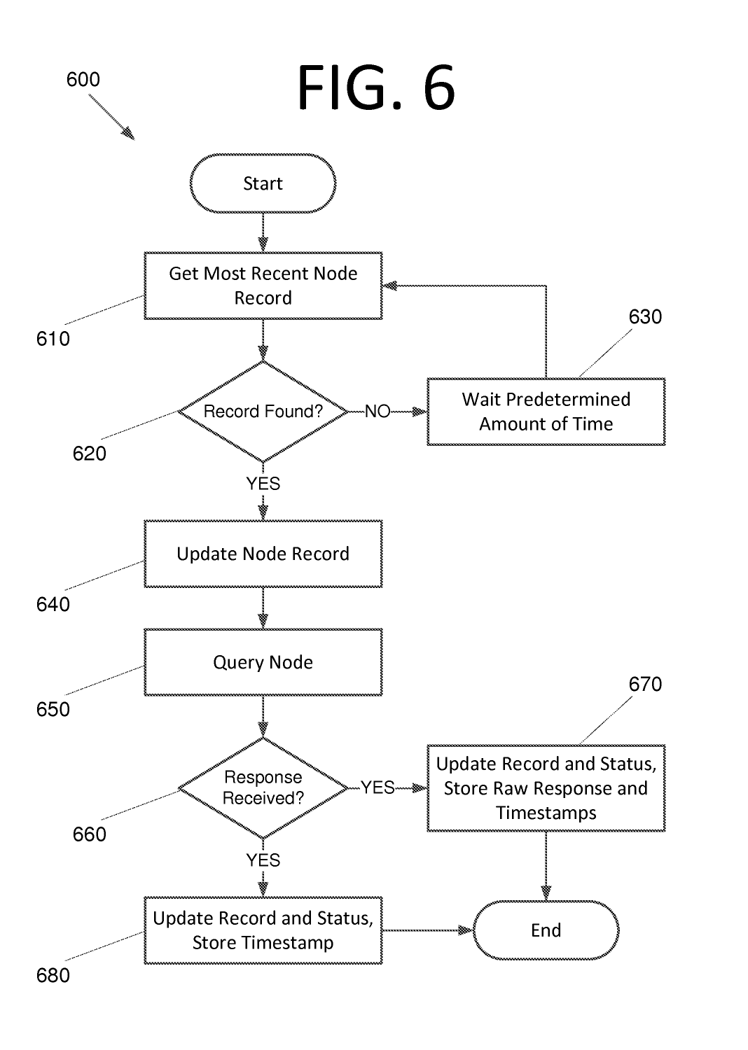

The processer may be responsible for querying unprocessed nodes and storing the response. FIG. 6 is a flowchart 600 illustrating a process for a processer, according to an embodiment of the present invention. The process begins with getting the most recent node record from the database that is in the “unprocessed” state and has a “not processed” status at 610. If no record was found at 620, the processer waits a configurable amount of time at 630, and then returns to 610 to check again.

If a record was found at 620, the node record in the database is updated at 640 to reflect the fact that processing has begun by updating its status to “started query.” The node in the distributed network is then queried at 650 by sending a request to its IP address and port. If a response is received at 660, the node record in the database is updated, the status is set to “queried,” and the raw response and the timestamps of when the request was sent and response was received are stored at 670. If a response is not received at 660, the node record in the database is updated, the status is set to “no response,” and the timestamp that the request was sent is stored at 680. The process then ends.

Parser

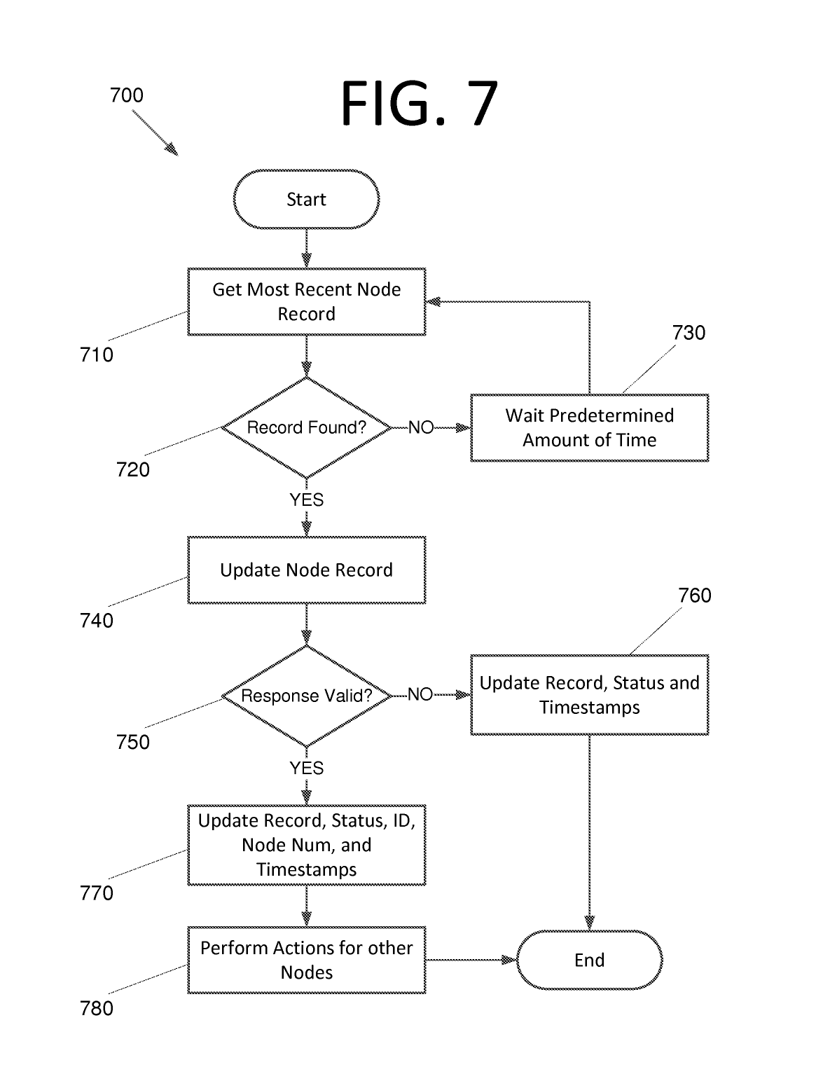

The parser may be responsible for parsing saved responses and storing records of new nodes. FIG. 7 is a flowchart 700 illustrating a process for a parser, according to an embodiment of the present invention. The process beings with getting the most recent node record from the database that is in the “processed” state and has a “queried” status at 710. If no record was found at 720, the parser waits a configurable amount of time at 730, and then returns to 710 to check again.

If a record was found at 720, the node record in the database is updated at 740 to reflect the fact that parsing has begun by updating its status to “started parse.” If the response length is less than the minimum valid response size or the response cannot be parsed at 750, and is thus invalid, the node record in the database is updated to reflect the fact that its response cannot be parsed, its status is set to “invalid response,” and the timestamp that parsing began and the timestamp that parsing was completed are set at 760. If the response can be parsed at 750, and is thus valid, the node record in the database is updated to reflect the fact that its response was successfully parsed by updating its status to “received nodes,” the client software identifier is set to reflect the client software running on the node as derived from the response, the number of other nodes in the distributed network received in the response is set, and the timestamp that parsing began and the timestamp that parsing was completed are set at 770. For each other node found in the parsed response, a record is saved to the database with the state “unprocessed” and the status “not processed,” as well as the node's IP address, port, and the timestamp that the node record was added at 780. The process then ends.

FIG. 8 is a flowchart 800 illustrating a process for profiling infringing activity, according to an embodiment of the present invention. The process begins with creating respective profiles for a plurality of infringing consumers based on observed patterns of infringing behavior at 805. In some embodiments, the consumer profile may include the IP address associated with the consumer, a timestamp that the infringed online content was first seen, a timestamp that the infringed online content was last seen, client software that the consumer was observed using, and a collection of audience groups to which the consumer belongs. A node record of an infringing event is created and stored at 810 for each instance of infringement by a consumer. The node record may include an Internet Protocol (IP) address associated with an infringing consumer, online content that is infringed, and a time that the infringing event occurred in some embodiments. The system then determines whether audience group metadata has been extrapolated from the infringed online content at 815, and extrapolates the audience group metadata from the infringed online content at 820 when the audience group metadata has not been extrapolated.

A share of a fee or a separate specific fee required by a copyright holder to access online infringement-based consumer segmentation data is transmitted to a marketer at 825. This enables the marketer to decide whether the fee is acceptable in order to obtain marketing data. The system then receives a request from the marketer for online infringement-based consumer segmentation data pertaining to a consumer infringing online content at 830. In some embodiments, input for the request for the consumer segmentation data may include an identity of the marketer, an authentication token, and an IP address.

The system authenticates the request and checks whether the marketer associated with the request is authorized at 835. If the marketer is authorized, the system sends a response to the marketer reflecting one or more segments into which the infringing consumer falls at 840. The system charges the marketer a fee for access to the online infringement-based consumer segmentation data pertaining to the consumer at 845 and provides a share of the fee, or a separate specific fee, to a copyright holder of the infringed online content at 850. The process then ends.

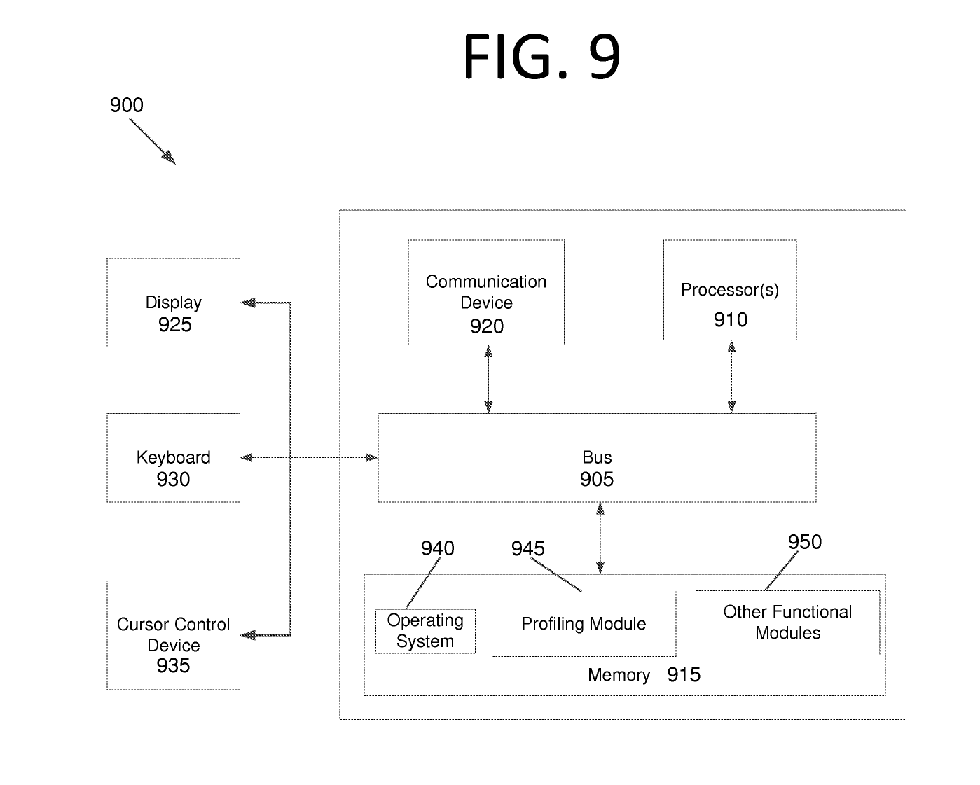

FIG. 9 is a block diagram illustrating a computing system 900, according to an embodiment of the present invention. Computing system 900 includes a bus 905 or other communication mechanism configured to communicate information, and at least one processor 910, coupled to bus 905, configured to process information. At least one processor 910 can be any type of general or specific purpose processor. Computing system 900 also includes memory 920 configured to store information and instructions to be executed by at least one processor 910. Memory 920 can be comprised of any combination of random access memory (“RAM”), read only memory (“ROM”), static storage such as a magnetic or optical disk, or any other type of computer readable medium. Computing system 900 also includes a communication device 915, such as a network interface card, configured to provide access to a network.

The computer readable medium may be any available media that can be accessed by at least one processor 910. The computer readable medium may include both volatile and nonvolatile medium, removable and non-removable media, and communication media. The communication media may include computer readable instructions, data structures, program modules, or other data and may include any information delivery media. The computer readable medium may be a data store containing records of infringing activity and consumer profiles in some embodiments, and/or the records and profiles may be distributed in a remote data store.

At least one processor 910 is coupled via bus 905 to a display 925, such as a Liquid Crystal Display (“LCD”). Display 925 may display information to the user. An input device 930 is also coupled to bus 905 to enable the user to interface with computing system 900.

Memory 920 stores software modules that provide functionality when executed by at least one processor 910. The modules include an operating system 940 and a profiling module 945 that may be configured to perform any of the processes discussed herein, as well as other functional modules 950. Operating system 940 provides operating system functionality for computing system 900.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 1-8 may be performed by a computer program, encoding instructions for the nonlinear adaptive processor to perform at least the processes described in FIGS. 1-8, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the processes described in FIGS. 1-8, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
receiving a request from a marketer, by a data store or a computing system associated with the data store, for online infringement-based consumer segmentation data pertaining to a consumer infringing online content;
authenticating the request and checking whether the marketer associated with the request is authorized, by the data store or the computing system associated with the data store; and
when the request is authenticated and the marketer is authorized, sending, by the data store or the computing system associated with the data store, a response to the marketer reflecting one or more segments into which the infringing consumer falls.

2. The computer-implemented method of claim 1, wherein input for the request for the consumer segmentation data comprises an identity of the marketer, an authentication token, and an IP address.

3. The computer-implemented method of claim 1, further comprising:
charging the marketer a fee, by the data store or the computing system associated with the data store, for access to the online infringement-based consumer segmentation data pertaining to the consumer; and
providing, by the data store or the computing system associated with the data store, a share of the fee, or a separate specific fee, to a copyright holder of the infringed online content.

4. The computer-implemented method of claim 3, further comprising:
transmitting, by the data store or the computing system associated with the data store, the share of the fee or the separate specific fee required by the copyright holder to access the online infringement-based consumer segmentation data to display on the marketer computing system.

5. The computer-implemented method of claim 1, further comprising:
creating, by the data store or the computing system associated with the data store, respective profiles for a plurality of infringing consumers based on observed patterns of infringing behavior.

6. The computer-implemented method of claim 5, further comprising:
creating and storing a node record of an infringing event, by the data store or the computing system associated with the data store, for each instance of infringement by a consumer.

7. The computer-implemented method of claim 6, wherein each node record comprises an Internet Protocol (IP) address associated with an infringing consumer, online content that is infringed, and a time that the infringing event occurred.

8. The computer-implemented method of claim 6, further comprising:
determining, by the data store or the computing system associated with the data store, whether audience group metadata has been extrapolated from the infringed online content; and
when the audience group metadata has not been extrapolated, extrapolating the audience group metadata from the infringed online content, by the data store or the computing system associated with the data store.

9. The computer-implemented method of claim 6, further comprising:
when a consumer profile does not exist for an Internet Protocol (IP) address associated with the consumer, creating the consumer profile, by the data store or the computing system associated with the data store.

10. The computer-implemented method of claim 9, wherein the consumer profile comprises the IP address associated with the consumer, a timestamp that the infringed online content was first seen, a timestamp that the infringed online content was last seen, client software that the consumer was observed using, and a collection of audience groups to which the consumer belongs.

11. The computer-implemented method of claim 1, wherein
the request by the marketer computing system comprises an Internet Protocol (IP) address of the infringing consumer, and
the IP address is received from a header of an HTTP request by the consumer to a website of the marketer.

12. The computer-implemented method of claim 1, further comprising:
periodically querying a plurality of nodes on a distributed network, by the data store or the computing system associated with the data store, regarding infringing activity of monitored content by consumers; and
evaluating responses from the plurality of nodes to identify the infringing activity of the monitored content.

13. The computer-implemented method of claim 12, further comprising:
performing initial queries of the plurality of nodes, by a bootstrapper of the data store or the computing system associated with the data store; and
saving respective node records of the responses, by the bootstrapper of the data store or the computing system associated with the data store.

14. The computer-implemented method of claim 13, wherein each node record comprises a content identifier, a material identifier, an Internet Protocol (IP) address, a port, a state, a status, a timestamp of when the node record was added, a client software identifier, a number of other nodes received in the response, a timestamp of when the request was sent to the node, a timestamp of when the response was received from the node, and a raw response received from the node.

15. The computer-implemented method of claim 13, further comprising:
retrieving, by a processer of the data store or the computing system associated with the data store, a most recent node record in an “unprocessed” state and with a “not processed” status;
updating the node record, by the processer of the data store or the computing system associated with the data store, to reflect the fact that processing has begun by updating the status of the node to “started query”;
querying the node, by the processer of the data store or the computing system associated with the data store, by sending a request to an Internet Protocol (IP) address and port of the node;
when a response is received from the node, updating the node record, setting the status to “queried,” and storing a raw response and timestamps of when the request was sent and the response was received, by the processer of the data store or the computing system associated with the data store; and
when a response is not received from the node, updating the node record in the database, setting the status to “no response,” and storing the timestamp that the request was sent, by the processer of the data store or the computing system associated with the data store.

16. The computer program of claim 13, further comprising:
retrieving, by a parser of the data store or the computing system associated with the data store, a most recent node record in a “processed” state and with a “queried” status;
updating the node record, by the parser of the data store or the computing system associated with the data store, to reflect the fact that parsing has begun by updating the status of the node to “started parse”;
when a length of a response received from the node is less than a minimum valid response size or the response cannot be parsed, updating the node record to reflect that the response cannot be parsed, setting the status to “invalid response,” and setting a timestamp that parsing began and a timestamp that parsing was completed, by the parser of the data store or the computing system associated with the data store; and
when the response can be parsed, updating the node record to reflect the fact that its response was successfully parsed by updating its status to “received nodes,” setting a client software identifier to reflect the client software running on the node, setting a number of other nodes in the distributed network received in the response, and setting a timestamp that parsing began and a timestamp that parsing was completed, by the parser of the data store or the computing system associated with the data store.

17. A computer program embodied on a non-transitory computer-readable medium, the program configured to cause at least one processor to:
transmit a share of a fee or a separate specific fee required by a copyright holder to access online infringement-based consumer segmentation data to a marketer;
receive a request from the marketer for online infringement-based consumer segmentation data pertaining to a consumer infringing online content;
authenticate the request and check whether the marketer associated with the request is authorized;
send a response to the marketer reflecting one or more segments into which the infringing consumer falls when the request is authenticated and the marketer is authorized;
charge the marketer a fee for access to the online infringement-based consumer segmentation data pertaining to the consumer; and
provide a share of the fee, or a separate specific fee, to a copyright holder of the infringed online content.

18. The computer program of claim 17, the program further configured to cause the at least one processor to:
create respective profiles for a plurality of infringing consumers based on observed patterns of infringing behavior;
create and store a node record of an infringing event for each instance of infringement by a consumer, the node record comprising an Internet Protocol (IP) address associated with an infringing consumer, online content that is infringed, and a time that the infringing event occurred;
determine whether audience group metadata has been extrapolated from the infringed online content; and
extrapolate the audience group metadata from the infringed online content when the audience group metadata has not been extrapolated.

19. An apparatus, comprising:
memory storing computer program instructions; and
at least one processor communicably coupled to the memory configured to execute the computer program instructions, wherein
the at least one processor is configured to:
periodically query a plurality of nodes on a distributed network regarding infringing activity of monitored content by consumers,
evaluate responses from the plurality of nodes to identify the infringing activity of the monitored content, and
create respective profiles for a plurality of infringing consumers based on observed patterns of infringing behavior in the evaluated responses.

20. The apparatus of claim 19, wherein the at least one processor is further configured to:
receive a request from a marketer for online infringement-based consumer segmentation data pertaining to a consumer infringing online content;
authenticate the request and check whether the marketer associated with the request is authorized; and
send a response to the marketer reflecting one or more segments into which the infringing consumer falls when the request is authenticated and the marketer is authorized.
